(19) United States
(12) Patent Application Publication
(10) Pub. No.: US 2006/0013246 A1
(43) Pub. Date: Jan. 19, 2006

(54) System, apparatus and method for gigabit ethernet communications over an IBM cabling system

(75) Inventors: Theodore Allen Gary, Apex, NC (US); Richard Habersham Le Sesne, Chapel Hill, NC (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 10/890,857

(22) Filed: Jul. 13, 2004

(51) Int. Cl. H04J 3/17

(52) U.S. Cl. 370/434

(57) ABSTRACT

A system, apparatus and method are provided which permit gigabit Ethernet communications over an IBM cabling system. An adapter is used to provide a connectivity solution for 1000 BaseTX, i.e. Gigabit Ethernet communications, in a facility that is wired with Type 2/2A STP IBM Cabling System cable. The adapter uses one of each of the current shielded data wires and one of each of the voice communications wires to provide the 8 wires needed for IEEE 802.3ab, i.e. Gigabit Ethernet, communications. Thus, the system, apparatus and method mate one of the wires from the shielded side with one of the wires from the unshielded side of a Type 2/2A STP IBM Cabling System cable at a RJ-45 Gigabit Ethernet (GbE) adapter. This pairing of an unshielded wire with a shielded wire helps to reduce cross-talk and other negative influences to the circuit. An additional RJ-11 adapter may be provided for the additional voice grade wires.

### BACKGROUND OF THE INVENTION

1. Technical Field

The present invention is directed to an improved data communication medium. More specifically, the present invention is directed to a system, apparatus and method which permit gigabit Ethernet communications over an IBM cabling system.

2. Description of Related Art

The IBM Cabling System is a cabling standard for Token-Ring networks. The original IBM Cabling System specification released in 1984 defined the 150 ohm shielded twisted pair (STP) cable types 1, 2, 6, 8 and 9 for support of frequencies up to 16 MHz. Later, an enhanced IBM Cabling System defined STP-A cable types 1A, 2A, 6A and 9A for support of Fiber Distributed Data Interface (FDDI) and frequencies up to 300 MHz. The “A” suffix denotes the enhanced IBM Cabling System. The original IBM Cabling System was defined in IBM publication GA27-3773. The enhanced, or STP-A, cabling system is defined in the TIA/EIA 568-A standard.

Generically, the term “shielded twisted pair” can be used to refer to any twisted pair cabling in which the pairs are enclosed in an outer shield. Individual pairs may also be shielded. However, the acronym “STP” most often refers to the 150 ohm shielded twisted pair cables defined by the IBM Cabling System specifications and used with Token-Ring networks. 150 ohm STP should not be confused with the 100 ohm shielded twisted pair used with Ethernet networks commonly known as “screened twisted pair” (ScTP) or “foil twisted pair” (FTP).

Type 1/1A STP is the stiff black cable most commonly associated with the IBM Cabling System. It contains two “data grade” shielded twisted pairs. Type 2/2A STP is the same as Type 1/1A except that it also contains four “voice grade” twisted pairs. The two data grade pairs are intended for data networking, such as Token-Ring networking, while the four voice grade pairs are intended for telephone communication connections. Type 2/2A STP allows a single cable to be routed to each office that supports both data and voice connections.

Many facilities have been wired using the Type 2/2A STP IBM Cabling System. Today, however, the Type 2/2A STP IBM Cabling System does not provide enough twisted pairs in the data connector to support Gigabit Ethernet (IEEE 802.3ab). Therefore, in order to permit Gigabit Ethernet networking, the cabling in these facilities must be removed and replaced to support Gigabit Ethernet networking. This re-cabling of the facilities causes great expense for the owners/operators of the facilities with regard to both the physical cables and connectors, and the labor for performing the re-cabling. Thus, it would be beneficial to have a system and method that permits existing IBM Cabling System cables to be used to provide Gigabit Ethernet networking.

### SUMMARY OF THE INVENTION

The present invention provides a system, apparatus and method which permit gigabit Ethernet communications over an IBM cabling system. With the present invention, an adapter is used to provide a connectivity solution for 1000 BaseTX, i.e. Gigabit Ethernet communications, in a facility that is wired with Type 2/2A STP IBM Cabling System cable. The adapter uses one of each of the current shielded data wires and one of each of the voice communications wires to provide the 8 wires needed for IEEE 802.3ab, i.e. Gigabit Ethernet, communications.

Thus, the present invention mates one of the wires from the shielded side with one of the wires from the unshielded side of a Type 2/2A STP IBM Cabling System cable at a RJ-45 Gigabit Ethernet (GbE) adapter. This pairing of an unshielded wire with a shielded wire helps to reduce cross-talk and other negative influences to the circuit. An additional RJ-11 adapter may be provided for the additional voice grade wires. These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a Type 2/2A STP IBM Cabling System cable in accordance with a known wiring system;

FIG. 2 is an exemplary diagram illustrating pairings of shielded and unshielded wires from a Type 2/2A STP IBM Cabling System cable to permit Gigabit Ethernet networking in accordance with the present invention;

FIG. 3 is an exemplary diagram illustrating a connection between a client/server and a LAN using adapters in accordance with one embodiment of the present invention; and

FIG. 4 is a flowchart outlining an exemplary operation of the present invention when modifying an existing Type 2/2A STP IBM Cabling System cable for use with Gigabit Ethernet networking.

### DETAILED DESCRIPTION OF THE PREFERRED EMBODIMENT

The present invention provides a system, apparatus and method for permitting existing Type 2/2A STP IBM Cabling System cables in a facility to be used for Gigabit Ethernet networking. The present invention includes an adapter that couples shielded and unshielded wires from the existing cables into pairs that may be used for Gigabit Ethernet network communications. An additional RJ-11 connector is provided for the additional voice grade wires so that they may be used for telephone communications. In this way, a facility that is wired using Type 2/2A STP IBM Cabling System cables need not be rewired in order to provide Gigabit Ethernet networking within the facility. In addition, since shielded and unshielded wires are paired using the adapter of the present invention, crosstalk and other negative effects are minimized.

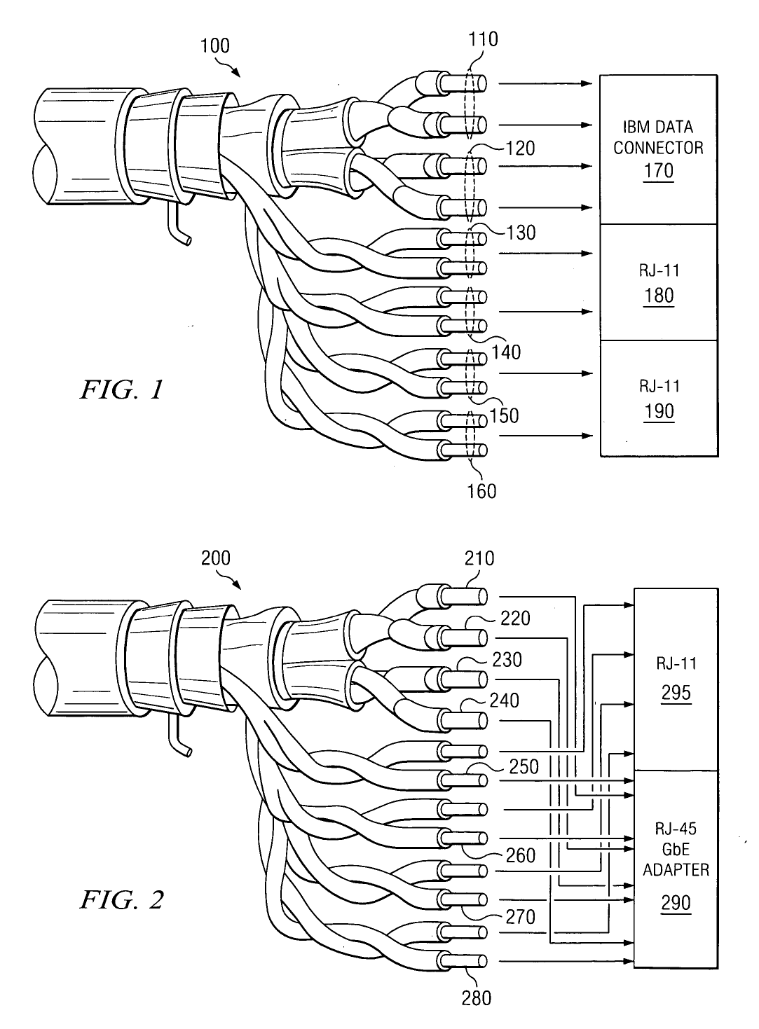

FIG. 1 is an exemplary diagram of a Type 2/2A STP IBM Cabling System cable in accordance with a known wiring system. As shown in FIG. 1, the known Type 2/2A STP IBM Cabling System wire 100 includes 12 wires organized into 6 twisted pairs 110-160. The first two twisted pairs 110-120 are shielded and are used for data communication. These pairs 110-120 interface with an IBM data connector 170 (for Token-Ring networking) in a wall plate (not shown) and permits a client/server or other network device to be coupled to the wire via the IBM data connector 170.

The third through sixth twisted pairs 130-160 are unshielded and provide telephone communication capability. The twisted pairs 130-140 are coupled to a first RJ-11 connector 180 and twisted pairs 150-160 are coupled to a second RJ-11 connector 190 in the wall plate. As a result, the known Type 2/2A STP IBM Cabling System cable provides a single data communication connection and two voice communication connections using a single cable.

The Gigabit Ethernet networking communication standard (IEEE 802.3ab) requires four twisted pairs of wires for data communication. Thus, the existing Type 2/2A STP IBM Cabling System cable, which includes only two twisted pairs 110-120 for data communication, is not sufficient for the Gigabit Ethernet networking communication standard. As a result, without the present invention, in order to permit a facility to take advantage of Gigabit Ethernet networking standard, the facility would need to have the existing cabling removed and new data cables meeting the Gigabit Ethernet standard and/or voice communication cables would need to be run within the facility to replace the removed cables. This would result in a great cost to the owner/operator of the facility.

The present invention eliminates the need to re-work the cabling in a facility that has been wired with Type 2/2A STP IBM Cabling System cable. The present invention works with the existing wires in the Type 2/2A STP IBM Cabling System cable to reorganize the wires into pairs that may be used to facilitate Gigabit Ethernet networking. As a result, re-working of the cabling in the facility is avoided, along with the extra cost that re-working would entail.

FIG. 2 is an exemplary diagram illustrating pairings of shielded and unshielded wires from a Type 2/2A STP IBM Cabling System to permit Gigabit Ethernet networking in accordance with the present invention. As shown in FIG. 2, the existing Type 2/2A STP IBM Cabling System cable 200 is utilized with a reorganization of the wires with respect to the connectors in the wall plate such that Gigabit Ethernet networking is made possible. As shown in FIG. 2, each of the data communication wires 210-240 are coupled with one of the voice communication wires 250-280 in the RJ-45 Gigabit Ethernet (GbE) adapter 290 of the present invention. The remaining voice communication wires are coupled to a RJ-11 adapter 295 to permit voice communication.

The data communication wires 210-240 are shielded while the voice communication wires 250-280 are not shielded. The pairing of a shielded data wire with a non-shielded voice communication wire aids in minimizing crosstalk and other negative effects that may exist in pairings of wires. The paired shielded and non-shielded wires are inserted into appropriately configured connections on one side of the RJ-45 GbE adapter 290 of the present invention. The pairing may be performed physically when inserting the wires into the RJ-45 GbE adapter 290 or may be performed by internal circuitry of the RJ-45 GbE adapter 290. That is, the RJ-45 GbE adapter 290 may have connecting pins for connecting to the various wires 210-280 without requiring a physical pairing of the wires external to the adapter 290. The pairing may be done within the adapter 290 by the circuitry contained therein.

On the other side of the RJ-45 GbE adapter 290, connectors are provided for a RJ-45 compatible Gigabit Ethernet cable that is connected to a client computing device, server computing device, or other network device, e.g., switch, router, etc. Thus, the computing devices and other network devices use Gigabit Ethernet cables and wires to connect to the RJ-45 GbE adapter 290 which then permits data to be sent over the paired shielded and non-shielded wires of the Type 2/2A STP IBM Cabling System cable to another network device.

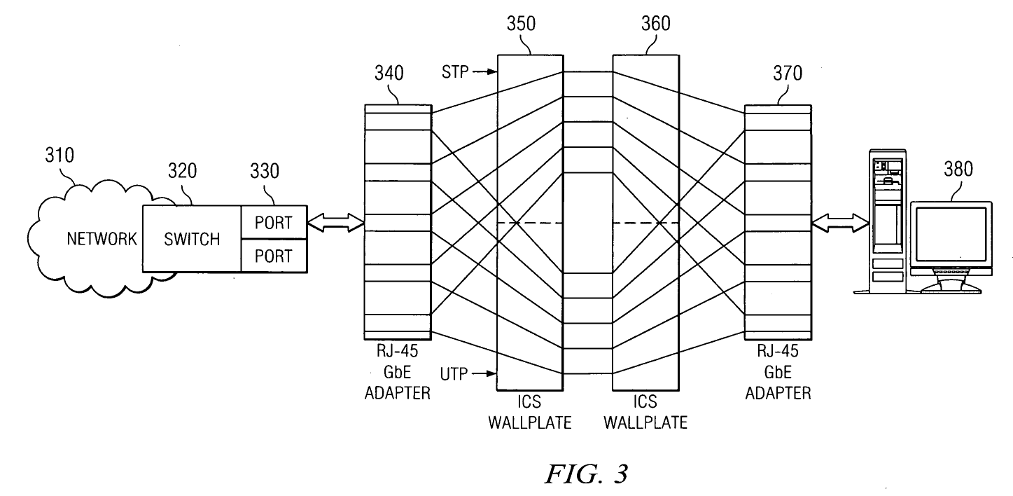

FIG. 3 is an exemplary diagram illustrating a connection between a client/server and a data network using adapters in accordance with one embodiment of the present invention. As shown in FIG. 3, the computing device 340, which may be a client, server, workstation, or other type of computing device, is coupled to an RJ-45 GbE adapter 370 using an appropriate communication cable according to the present invention. This RJ-45 GbE adapter 370 is coupled to an Internet Connection Sharing (ICS) wallplate 360. A cable is run from the ICS wallplate 360 to the ICS wallplate 350. A similar RJ-45 GbE adapter 340 is coupled to the wallplate 350. A network switch 320 may then be coupled to the RJ-45 GbE adapter 340 via port 330 and an appropriate communication cable that connects to the RJ-45 GbE adapter 340.

The depicted wires running between ICS wallplate 360 and ICS wallplate 350 are part of a single Type 2/2A STP IBM Cabling System cable. For example, this Type 2/2A STP IBM Cabling System cable may be an existing cable in the wiring of a facility. As shown in FIG. 3, wires of the Type 2/2A STP IBM Cabling System cable are paired in such a way as to permit Gigabit Ethernet communication over the Type 2/2A STP IBM Cabling System cable. As shown in FIG. 3, each pair of wires at each RJ-45 GbE adapter 340 and 370 is comprised of a wire from a shielded twisted pair of wires (STP wires) and a wire from an unshielded twisted pair of wires (UTP wires)(only the wires involved in the data communication are shown, 4 other wires are utilized for voice communication). As mentioned above, the pairing of a shielded wire and an unshielded wire in the manner performed by the RJ-45 GbE adapter of the present invention aids in reducing the amount of crosstalk experienced by the wires and other negative effects on the signals transmitted by the wires.

The result of the application of the present invention is a set of 4 pairs of wires over which data communications may be permitted. This meets Gigabit Ethernet specifications (IEEE 802.3ab). As a result, the computing device 340 may communicate with the switch 320 of the Gigabit Ethernet data network 310 using Gigabit Ethernet communication capability using existing Type 2/2A STP IBM Cabling System cables.

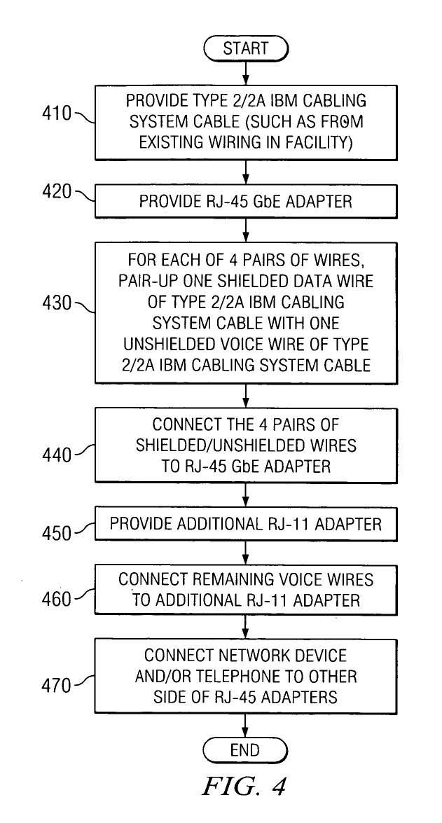

FIG. 4 is a flowchart outlining an exemplary operation of the present invention when modifying an existing Type 2/2A STP IBM Cabling System wire for use with Gigabit Ethernet networking. As shown in FIG. 4, the operation starts by providing a Type 2/2A STP IBM Cabling System cable (step 410). For example, this cable may be part of existing cabling in a facility or may be added to the facility as part of the present operation. An RJ-45 GbE adapter according to the present invention is then provided (step 420). Four pairs of data communication wires are generated by pairing one shielded data wire of the Type 2/2A STP IBM Cabling System cable to one unshielded voice wire of the Type 2/2A STP IBM Cabling System cable (step 430). This is done four times in order to provide the four pairs of data communication wires.

The resulting four pairs of shielded/unshielded wires are then connected to wire ports in the RJ-45 GbE adapter (step 440). An additional RJ-11 adapter is then provided for the remaining voice wires from the Type 2/2A STP IBM Cabling System cable (step 450). These voice wires are connected to the additional RJ-11 adapter (step 460). A network device, such as a server, client, workstation, etc., and/or telephone device is then connected to the other side of the RJ-45 adapters using a suitable RJ-45 compatible Gigabit Ethernet cable (step 470). The operation then ends.

Thus, the present invention provides a mechanism by which existing IBM Cabling System cables may be used to support Gigabit Ethernet communications. This results in avoiding having to rework the existing cabling in a facility to have Gigabit Ethernet capable cables. Rather, adapters according to the present invention may be provided that pair up shielded data wires and unshielded voice wires from the IBM Cabling System cables to provide the required number of data wires to provide Gigabit Ethernet communication. The additional wires may be used for voice communication.

It should be noted that while the present invention has been described in terms of pairing up wires in a Type 2/2A STP IBM Cabling System cable to permit Gigabit Ethernet data communication, the present invention is not limited to such. Rather, any cables that provide a sufficient number of data and voice wires that may be paired to provide the requisite number of data communication wires for Gigabit Ethernet data communications may be used without departing from the spirit and scope of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of coupling a computing device to a data network, comprising:
providing a data communication cable having a first set of wires that are shielded data communication wires and a second set of wires that are unshielded voice communication wires;
for each of a plurality of pairs, pairing one wire from the first set of wires with one wire from the second set of wires; and
coupling the plurality of pairs of wires to data communication adapter, wherein the data communication cable is coupled to the data network and wherein the data communication adapter is coupled to the computing device.

2. The method of claim 1, wherein the data communication cable is a Type 2/2A STP IBM Cabling System cable.

3. The method of claim 1, wherein the data communication adapter is a RJ-45 Gigabit Ethernet adapter.

4. The method of claim 1, further comprising:
coupling additional wires from the second set of wires to an RJ-11 adapter.

5. The method of claim 1, wherein the plurality of pairs of wires permit Gigabit Ethernet data communication between the computing device and the data network.

6. The method of claim 5, wherein the data communication cable is a cable that is pre-existing in a facility and is not originally designed for Gigabit Ethernet data communication.

7. The method of claim 1, wherein the plurality of pairs is four pairs of wires, each pair including a shielded data wire from the first set of wires and an unshielded voice wire from the second set of wires.

8. A system for data communication, comprising:
a computing device;
a data network;
a data communication cable coupled to the data network; and
a data communication adapter coupled to the data communication cable and the computing device, wherein the data communication cable has a first set of wires that are shielded data communication wires and a second set of wires that are unshielded voice communication wires, and wherein the data communication adapter, for each of a plurality of pairs of wires, pairs one wire from the first set of wires with one wire from the second set of wires.

9. The system of claim 8, wherein the data communication cable is a Type 2/2A STP IBM Cabling System cable.

10. The system of claim 8, wherein the data communication adapter is a RJ-45 Gigabit Ethernet adapter.

11. The system of claim 8, further comprising:
an RJ-11 adapter coupled to additional wires, not coupled to the data communication adapter, in the second set of wires.

12. The system of claim 8, wherein the plurality of pairs of wires permit Gigabit Ethernet data communication between the computing device and the data network.

13. The system of claim 12, wherein the data communication cable is a cable that is pre-existing in a facility and is not originally designed for Gigabit Ethernet data communication.

14. The system of claim 8, wherein the plurality of pairs is four pairs of wires, each pair including a shielded data wire from the first set of wires and an unshielded voice wire from the second set of wires.

15. An apparatus coupling a computing device to a data network, comprising:
a first plurality of ports for coupling the apparatus to a first data communication cable coupled to the data network; and
a second plurality of ports for coupling the apparatus to a second data communication cable coupled to the computing device, wherein the first data communication cable has a first set of wires that are shielded data communication wires and a second set of wires that are unshielded voice communication wires, and wherein the first plurality of ports facilitate pairing, for each of a plurality of pairs of wires, one wire from the first set of wires with one wire from the second set of wires.

16. The apparatus of claim 15, wherein the first data communication cable is a Type 2/2A STP IBM Cabling System cable.

17. The apparatus of claim 15, wherein the first set of ports and the second set of ports are provided in a RJ-45 Gigabit Ethernet adapter.

18. The apparatus of claim 15, further comprising:
an RJ-11 adapter to which additional wires from the second set of wires are able to be coupled.

19. The apparatus of claim 15, wherein the plurality of pairs of wires permit Gigabit Ethernet data communication between the computing device and the data network.

20. The apparatus of claim 15, wherein the plurality of pairs is four pairs of wires, each pair including a shielded data wire from the first set of wires and an unshielded voice wire from the second set of wires.
